(19) United States
(12) Patent Application Publication
(10) Pub. No.: US 2024/0326661 A1
(43) Pub. Date: Oct. 3, 2024

(54) VEHICLE SEAT, IN PARTICULAR MOTOR VEHICLE SEAT

(71) Applicant: Adient US LLC, Plymouth, MI (US)

(72) Inventor: Ludger MUEHLENBROCK, Recklinghausen (DE)

(73) Assignee: Adient US LLC, Plymouth, MI (US)

(21) Appl. No.: 18/590,288

(22) Filed: Feb. 28, 2024

(30) Foreign Application Priority Data
Mar. 28, 2023 (DE) 10 2023 107 835.6
Jul. 3, 2023 (DE) 10 2023 117 435.5

(51) Int. Cl. B60N 2/22; B60N 2/68

(52) U.S. Cl. CPC B60N 2/2222; B60N 2/688

(57) ABSTRACT

A vehicle seat may have a first seat component that may be a backrest lower portion, a second seat component which can be pivoted about a pivot axis relative to the first seat component, in particular a backrest upper portion. The second seat component may have a slotted guiding member, a journal which is movably guided in the slotted guiding member of the second seat component, and an actuator for displacing the journal within the slotted guiding member. The first seat component may have a slotted support member in which the journal is movably guided, where the slotted guiding member and the slotted support member may intersect with each other in an intersection region.

### FIELD

The invention relates to a vehicle seat, in particular a motor vehicle seat, having a first seat component, in particular a backrest lower portion of a backrest, a second seat component which can be pivoted about a pivot axis relative to the first seat component, in particular a backrest upper portion of the backrest, the second seat component having a slotted guiding member, a journal which is movably guided in the slotted guiding member of the second seat component, and an actuator for displacing the journal within the slotted guiding member.

### BACKGROUND

DE 197 26 800 A1 discloses a backrest for a motor vehicle, having an adjustment device for pivoting a backrest head with respect to a backrest lower portion about a horizontal pivot axis, wherein the adjustment device is in the form of a rotary adjustment device which can be rotated about a horizontal rotation axis. An arm which is securely connected to an output region of the rotary adjustment device is connected with the free end thereof via an elongate hole guide to the backrest head, wherein the arm has a journal which engages in an elongate hole region which is located in the backrest head.

DE 199 19 698 A1 discloses a vehicle seat, in particular a motor vehicle seat, having a seat structure in which a backrest upper portion can be pivoted relative to a backrest lower portion, wherein the backrest upper portion pivots forwards in the event of a crash. To this end, the backrest upper portion is pivotably articulated by a joint to an upper end of the backrest lower portion. An upper pin is guided eccentrically by the joint in a slotted member of a slotted guiding member.

DE 10 2007 027 320 B3 discloses a backrest for a motor vehicle, having a backrest lower portion, a backrest upper portion which is pivotably supported about a pivot axis on the backrest lower portion, a slotted guiding member which limits a maximum pivot angle of the backrest upper portion, and a plastics material insert as an intermediate layer between the backrest lower portion and the backrest upper portion in the region of the slotted guiding member. At both sides of the backrest, there is connected in each case to the backrest lower portion a stop pin which is guided in a corresponding slotted guiding member which is formed in the backrest upper portion.

WO 2022/049032 A1 discloses a vehicle seat having a seat portion and a backrest which can be adjusted in terms of inclination, wherein the backrest has a backrest lower portion which can be pivoted about a first pivot axis relative to the seat portion and a backrest upper portion which is arranged on the backrest lower portion so as to be able to be pivoted about a second pivot axis, wherein the backrest upper portion can be locked by at least one joint fitting in terms of its inclination.

### SUMMARY

An object of the invention is to improve a vehicle seat of the type mentioned in the introduction, in particular to increase the strength of an adjustment apparatus for adjusting a backrest upper portion relative to a backrest lower portion.

This object is achieved according to the invention with a vehicle seat, in particular motor vehicle seat, having a first seat component, in particular a backrest lower portion of a backrest, a second seat component which can be pivoted about a pivot axis relative to the first seat component, in particular a backrest upper portion of the backrest, the second seat component having a slotted guiding member, a journal which is movably guided in the slotted guiding member of the second seat component, and an actuator for displacing the journal within the slotted guiding member, wherein the first seat component has a slotted support member, in which the journal is movably guided, wherein the slotted guiding member and the slotted support member intersect with each other in an intersection region.

The first seat component has a slotted support member which intersects with the slotted guiding member in the intersection region and in which the journal is also movably guided. By displacing the journal within the slotted guiding member, the journal can also be displaced within the slotted support member or, by displacing the journal within the slotted support member, the journal can also be displaced within the slotted guiding member.

As a result of the fact that the slotted guiding member and the slotted support member intersect with each other in the intersection region, by displacing the journal within the slotted guiding member and the slotted support member, the first seat component and the second seat component can be pivoted relative to each other about the pivot axis. By displacing the journal within the slotted guiding member, the intersection region can consequently be displaced along the slotted guiding member, whereby a relative angular position between the first seat component and the second seat component can be adjusted.

A backrest may have a backrest lower portion and a backrest upper portion which is pivotably supported on the backrest lower portion about the pivot axis. The first seat component may be a backrest lower portion of the backrest. The second seat component may be a backrest upper portion, which can be pivoted relative to the backrest lower portion, of the backrest.

The invention is not limited to an application in a backrest. Thus, the first seat component may, for example, be a seat frame of a seat portion. The second seat component may be a seat shell, which can be pivoted relative to the seat frame, of the seat portion.

The slotted guiding member and the slotted support member may be arranged eccentrically relative to the pivot axis, in particular above the pivot axis.

The actuator may have an electric motor and at least one spindle gear. The actuator may have precisely one electric motor and two spindle gears which are arranged at opposing sides of the vehicle seat. The at least one spindle gear may have a gear mechanism housing and a threaded spindle.

Alternatively, an actuator having an electric motor and a spindle gear is arranged at each side of the vehicle seat, wherein a slotted guiding member, a slotted support member and a journal are associated with the actuator in each case.

The journal may be secured to the threaded spindle. The journal may be secured directly to the threaded spindle. The journal may be secured indirectly to the threaded spindle. The journal may be arranged in an end region of the threaded spindle. The journal may be secured to the threaded spindle in an end region of the threaded spindle.

A slotted guiding member, at least one slotted support member and a journal may be arranged at two, for example, when viewed in the transverse direction, mutually opposing sides of the vehicle seat, in particular at each of two sides of a backrest upper portion of a backrest. The journal extends in the intersection region through both the slotted guiding member and the slotted support member.

Alternatively, a slotted guiding member, a slotted support member and a journal may be arranged at only one side, in particular at precisely only one side of a vehicle seat. Such a single-sided arrangement may in particular be sufficient with a vehicle seat without belt integration in the backrest.

The first seat component and the second seat component may overlap each other in an overlapping region. The slotted guiding member and the slotted support member may be arranged in the overlapping region.

The journal and the slotted guiding member may in at least one pivot direction form an end stop for the pivot movement of the second seat component relative to the first seat component about the pivot axis. The journal and the slotted guiding member may in two (in particular mutually opposed) pivot directions in each case form an end stop for the pivot movement of the second seat component relative to the first seat component about the pivot axis.

The journal and the slotted support member may in at least one pivot direction form an end stop for the pivot movement of the second seat component relative to the first seat component about the pivot axis. The journal and the slotted support member may in two (in particular mutually opposed) pivot directions in each case form an end stop for the pivot movement of the second seat component relative to the first seat component about the pivot axis.

The journal, on the one hand, and the slotted guiding member and the slotted support member, on the other hand, may form in at least one pivot direction an end stop for the pivot movement of the second seat component relative to the first seat component about the pivot axis. The journal, on the one hand, and the slotted guiding member and the slotted support member, on the other hand, may in two (in particular mutually opposed) pivot directions in each case form an end stop for the pivot movement of the second seat component relative to the first seat component about the pivot axis.

The vehicle seat may be an integrated-belt seat. A belt outlet location may be integrated in a backrest upper portion of a backrest of the integrated-belt seat. A backrest lower portion of the backrest of the integrated-belt seat may have a first backrest side portion and a second backrest side portion. In this instance, the second backrest side portion may, when viewed in the transverse direction, be arranged closer to the belt outlet location than the first backrest side portion. The second backrest side portion may have a first profile metal sheet and a second profile metal sheet which are connected to form a hollow profile. Both the first profile metal sheet and the second profile metal sheet may in each case have a slotted support member which receive a common journal. The slotted support member of the first profile metal sheet and the slotted support member of the second profile metal sheet may have an identical shape. The slotted support member of the first profile metal sheet and the slotted support member of the second profile metal sheet may be arranged in a state spaced apart from each other. The slotted support member of the first profile metal sheet and the slotted support member of the second profile metal sheet may be arranged in a state offset from each other in the transverse direction.

The slotted guiding member may be an elongate hole. The slotted guiding member may be a linearly extending elongate hole. The slotted guiding member may be a curved elongate hole. A sliding bush, in particular for guiding the journal, may be arranged in the slotted guiding member.

The slotted support member may be an elongate hole. The slotted support member may be a linearly extending elongate hole. The slotted support member may be a curved elongate hole. A sliding bush, in particular for guiding the journal, may be arranged in the slotted guiding member.

The slotted guiding member and the slotted support member are preferably arranged eccentrically relative to the pivot axis. The slotted guiding member and the slotted support member may be arranged completely above the pivot axis. The slotted guiding member and the slotted support member may in each case have the same shape. The slotted guiding member and the slotted support member may have a different shape. The slotted guiding member and the slotted support member may be arranged in a state rotated relative to each other. The slotted guiding member and the slotted support member may be arranged in a state displaced relative to each other. The slotted guiding member and the slotted support member may be arranged in a state displaced and rotated relative to each other.

The journal may be a cam. The journal may be a sliding element. The journal may be a pin. The journal may be a bolt. The journal may have a circular cross section. The journal may have a non-round cross section. The journal may have an oval cross section. The journal may have a polygonal cross section.

In summary and in other words, as a result of the invention, a backrest head adjustment for a vehicle seat, in particular for an integrated-belt seat, is provided. A lower, fixed portion of the backrest receives a pivot and a slot. The same is provided in the upper, movable portion of the backrest. In the two slots which are arranged obliquely with respect to each other, a bolt is moved by a drive so that the upper portion of the seat backrest moves about the pivot. A headrest having additional adjustment possibilities is also moved. This construction is particularly suitable in order to be able to absorb all the forces which are introduced by a belt system which is installed on the vehicle seat into the backrest. The invention additionally supports the possibility of assuming a comfortable “relax position” (inclined position, for example, described in DE 10 2018 203 731 A1), in which the support for the head and shoulder region is different with respect to a position for use of the vehicle seat.

The invention enables legal provisions to be complied with for a rear impact, in which the risk of whiplash is evaluated. As a result of a load distribution achieved, backrest adjustment fittings (recliners) with a lower level of strength which afford a cost advantage can be used. A load discharge is carried out not by the mechanism (actuator) used but instead only via the structural components of the backrest. The mechanism is only required for adjustment. The construction is configured in such a manner that the upper portion of the backrest does not become thicker. A slim structural shape is thereby achieved.

### DESCRIPTION OF THE FIGURES

The invention is explained in greater detail below with reference to an advantageous exemplary embodiment illustrated in the Figures. However, the invention is not limited to this exemplary embodiment. In the drawings:

FIG. 1: shows a schematic side view of a vehicle seat according to the invention,

FIG. 2: shows a cut-out of a perspective view, obliquely from the front, of a backrest of the vehicle seat from FIG. 1, wherein a backrest cushion is not illustrated,

FIG. 3: shows a cut-out of a front view of the backrest from FIG. 2,

FIG. 4: shows a cut-out of a perspective view, obliquely from the rear, of the backrest from FIG. 2,

FIG. 5: shows a cut-out of a side view of the backrest from FIG. 2, wherein a backrest upper portion is pivoted backwards to the maximum extent with respect to a backrest lower portion,

FIG. 5A: shows an enlarged cut-out from FIG. 5,

FIG. 6: shows a cut-out of a side view of the backrest from FIG. 2, wherein the backrest upper portion is pivoted forwards to the maximum extent with respect to the backrest lower portion,

FIG. 6A: shows an enlarged cut-out from FIG. 6,

FIG. 7: shows a cut-out of a perspective view of the backrest from FIG. 2, wherein the backrest upper portion is pivoted backwards to the maximum extent with respect to the backrest lower portion, and

FIG. 8: shows a cut-out of a perspective view of the backrest from FIG. 2, wherein the backrest upper portion is pivoted forwards to the maximum extent with respect to the backrest lower portion.

### DETAILED DESCRIPTION

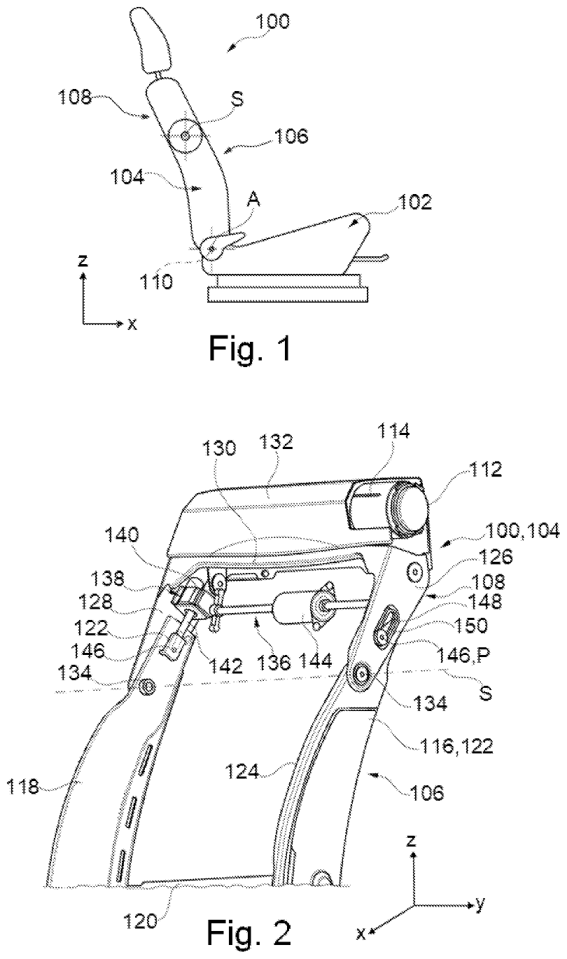

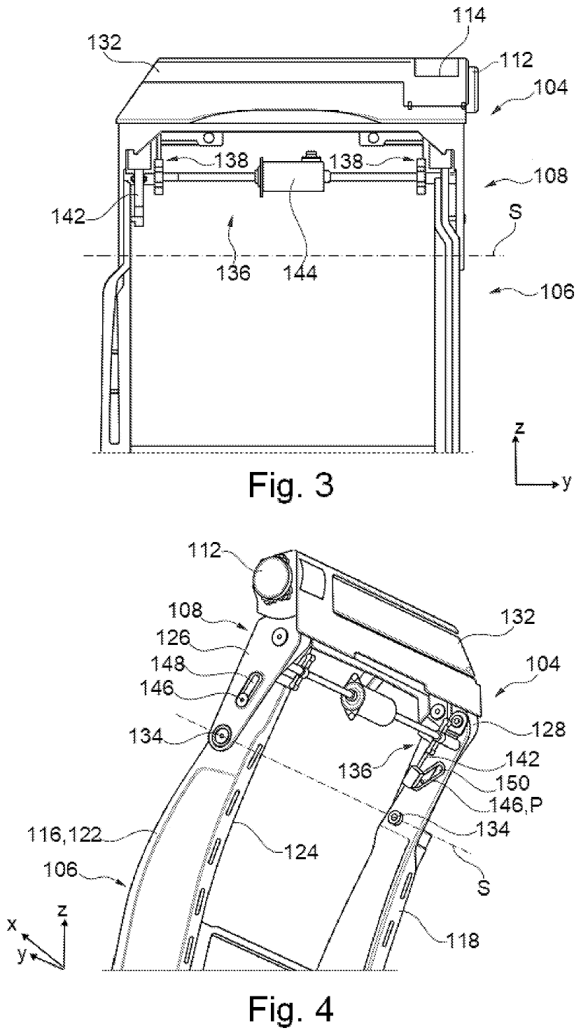

FIGS. 1 to 8 show a vehicle seat 100 according to the invention. The vehicle seat 100 which is illustrated only schematically in FIG. 1 is described below using three spatial directions which extend perpendicularly to each other. A longitudinal direction x extends in a vehicle seat 100 which is installed in the vehicle substantially in a horizontal manner and preferably parallel with a longitudinal vehicle direction, which corresponds to the usual travel direction of the vehicle. A transverse direction y which extends perpendicularly to the longitudinal direction x is also orientated horizontally in the vehicle and extends parallel with a transverse vehicle direction. A vertical direction z extends perpendicularly to the longitudinal direction x and perpendicularly to the transverse direction y. With a vehicle seat 100 which is installed in the vehicle, the vertical direction z extends parallel with the vertical vehicle axis.

The position and direction indications used, such as, for example, front, rear, top and bottom, relate to a viewing direction of a passenger seated in the vehicle seat 100 in a normal seating position, wherein the vehicle seat 100 is installed in the vehicle in a position for use which is suitable for transporting persons with an upright backrest 104 and is orientated as usual in the direction of travel. The vehicle seat 100 according to the invention may, however, also be installed in a different orientation, for example, transversely relative to the travel direction.

Unless otherwise described in detail below, the vehicle seat 100 is constructed in a mirror-symmetrical manner with respect to a plane which extends perpendicularly to the transverse direction y. In FIGS. 2 to 8, the seat portion 102 and the backrest 104 are in each case illustrated without associated upholstery elements.

The backrest 104 of the vehicle seat 100 has a backrest lower portion 106 which can be pivoted about a backrest pivot axis A relative to the seat portion 102 and a backrest upper portion 108 which is articulated to the backrest lower portion 106 so as to be pivotable about a pivot axis S. The backrest pivot axis A and the pivot axis S extend in this instance in each case parallel with the transverse direction y. The pivot axis S is arranged above the backrest pivot axis A.

The backrest 104 can be adjusted about the backrest pivot axis A in terms of its inclination relative to the seat portion 102. To this end, the backrest lower portion 106 which can be pivoted relative to the seat portion 102 can be pivoted about the backrest pivot axis A by two joint fittings 110 in this case and locked in terms of its inclination. The joint fittings 110 may, for example, be locking fittings or gear mechanism fittings.

The vehicle seat 100 is in this instance an integrated-belt seat in which a belt retractor 112 and an upper belt outlet location 114 for a shoulder belt of a 3-way safety belt system are arranged in an upper region of the backrest 104.

The backrest lower portion 106 is substantially U-shaped. The backrest lower portion 106 has a first backrest side portion 116 and a second backrest side portion 118. The two backrest side portions 116, 118 are spaced apart from each other (in the transverse direction y) and connected to each other by a cross-beam 120. The cross-beam 120 is arranged in a lower region of the backrest lower portion 106.

The first backrest side portion 116 is (when viewed in the transverse direction y) arranged at the side of the belt outlet location 114. The second backrest side portion 118 is (when viewed in the transverse direction y) arranged at the side facing away from the belt outlet location 114. As a result of the fact that the first backrest side portion 116 is arranged at the side of the belt outlet location 114, the first backrest side portion 116 is in the event of a crash more powerfully loaded by the 3-point safety belt system than the second backrest side portion 118. The first backrest side portion 116 therefore has a higher rigidity than the second backrest side portion 118. In this instance, the first backrest side portion 116 has a first profile metal sheet 122 and a second profile metal sheet 124 which are connected to each other, preferably welded, in such a manner that the first backrest side portion 116 is in the form of a hollow profile.

The backrest upper portion 108 is substantially U-shaped. The backrest upper portion 108 has a first side member 126 and a second side member 128. The two side members 126, 128 are spaced apart from each other (in the transverse direction y) and connected by a transverse strut 130. The transverse strut 130 is arranged in an upper region of the backrest upper portion 108. A structural component 132 which has the belt retractor 112 and the belt outlet location 114 is connected to the transverse strut 130, as known, for example, from WO 2020/083706 A1.

The upper end regions of the backrest side portions 116, 118 of the backrest lower portion 106 and the lower end regions of the side members 126, 128 of the backrest upper portion 108 overlap each other, that is to say, the upper end region of the first backrest side portion 116 is arranged directly laterally adjacent to the lower end region of the first side member 126 and the upper end region of the second backrest side portion 118 is arranged directly laterally adjacent to the lower end region of the second side member 128. An overlapping region is thereby defined at both sides.

The backrest upper portion 108 is connected to the backrest lower portion 106 so as to be pivotable about the pivot axis S by two rotary bearings 134. A rotary bearing 134 is arranged in both overlapping regions in each case. In order to adjust the backrest upper portion 108, that is to say, in order to pivot the backrest upper portion 108 about the pivot axis S and to secure the adjusted angular position of the backrest upper portion 108, the vehicle seat 100 has an actuator 136.

In this instance, the actuator 136 has two spindle gears 138 which each comprise a gear mechanism housing 140, a spindle nut which is rotatably supported in the gear mechanism housing 140 and a threaded spindle 142 which is screwed into the spindle nut. The two spindle gear mechanisms 138 are driven by a central electric motor 144 which is arranged substantially centrally between the two spindle gear mechanisms 138. By supplying electrical power to the electric motor 144, the spindle nuts are rotated and the two threaded spindles 142 are thereby displaced synchronously relative to the gear mechanism housings 140 which are associated therewith.

The two gear mechanism housings 140 and the electric motor 144 are secured to the backrest upper portion 108. One of the two gear mechanism housings 140 is arranged in the region of the first side member 126. The other of the two gear mechanism housings 140 is arranged in the region of the second side member 128. The threaded spindles 142 extend substantially parallel with the side members 126, 128.

A journal 146 (in this instance, in the form of a pin) is secured to the two threaded spindles 142. The two journals 146 extend preferably parallel with the transverse direction y and the longitudinal axes thereof are in alignment with each other. The two journals 146 are in this instance each secured to an end region, facing away from the associated gear mechanism housing 140, of the associated threaded spindle 142.

The first side member 126 and the second side member 128 of the backrest upper portion 108 have in each case a slotted guiding member 148, which members are in this instance in the form of an elongate hole. The first backrest side portion 116 and the second backrest side portion 118 of the backrest lower portion 106 have in each case a slotted support member 150, which members are in this instance in the form of an elongate hole. Both the first profile metal sheet 122 and the second profile metal sheet 124 of the first backrest side portion 116 have in each case a slotted support member 150.

The slotted guiding members 148 and the slotted support members 150 are in each case arranged eccentrically with respect to the pivot axis S. The slotted guiding members 148 and the slotted support members 150 are in each case arranged in one of the overlapping regions. The slotted guiding members 148 and the slotted support members 150 are not arranged in a congruent manner, but instead preferably in a state rotated relative to each other.

The slotted guiding member 148 in the second side member 128 of the backrest upper portion 108 is located at the side of the slotted support member 150 in the second backrest side portion 118 of the backrest lower portion 106, wherein the slotted guiding member 148 intersects with the slotted support member 150 in an intersection region P. In the intersection region P, the journal 146 of the associated spindle gear 138 extends through both the slotted guiding member 148 and the slotted support member 150. By supplying electrical power to the electric motor 144, the journal 146 is moved in the slotted guiding member 148. Since the slotted guiding member 148 is not congruent with the slotted support member 150, the journal 146 pivots the slotted guiding member 148 and the slotted support member 150 relative to each other about the pivot axis S with the intersection region P being displaced. The backrest upper portion 108 and the backrest lower portion 106 are thereby pivoted relative to each other about the pivot axis S. The intersection region P is arranged eccentrically relative to the pivot axis S.

In a similar manner, the slotted guiding member 148 in the first side member 126 of the backrest upper portion 108 and the two slotted support members 150 in the first backrest side portion 116 of the backrest lower portion 106 cooperate with each other.

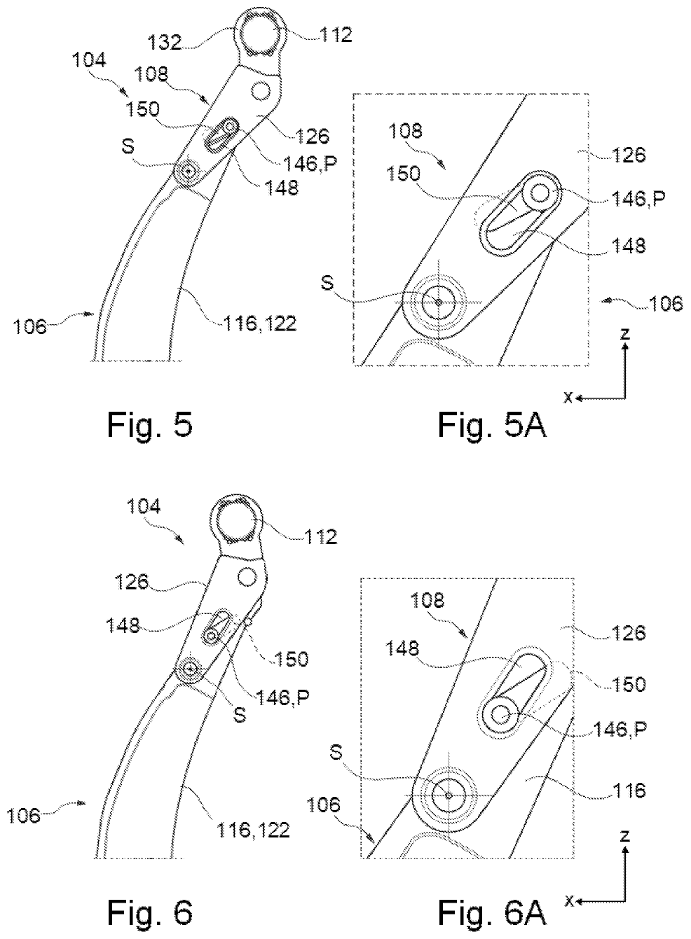

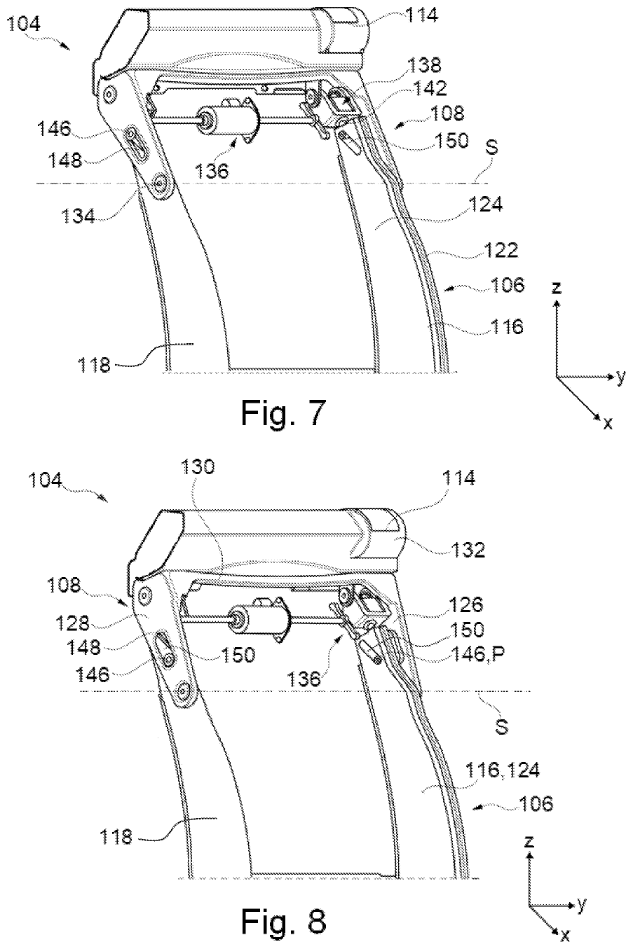

A pivot region of the backrest upper portion 108 relative to the backrest lower portion 106 about the pivot axis S is limited by the length of the slotted guiding members 148. The pivot region is limited in a backward direction by the journals 146 moving into abutment against an upper end region of the slotted guiding member 148 (see in particular FIGS. 5 and 7). The pivot region is limited in a forward direction by the journals 146 moving into abutment against a lower end region of the slotted guiding member 148 (see in particular FIGS. 6 and 8).

The features disclosed in the above description, the claims and the drawings may be significant both individually and in combination for implementing the invention in its various embodiments.

### LIST OF REFERENCE NUMERALS

100 Vehicle seat
102 Seat portion
104 Backrest
106 Backrest lower portion
108 Backrest upper portion
110 Joint fitting
112 Belt retractor
114 Belt outlet location
116 First backrest side portion
118 Second backrest side portion
120 Cross-beam
122 First profile metal sheet
124 Second profile metal sheet
126 First side member
128 Second side member
130 Transverse strut
132 Structural component
134 Rotary bearing
136 Actuator
138 Spindle gear
140 Gear mechanism housing
142 Threaded spindle
144 Electric motor
146 Journal
148 Slotted guiding member
150 Slotted support member
x Longitudinal direction
y Transverse direction
z Vertical direction
A Backrest pivot axis
S Pivot axis
P Intersection region

1-10. (canceled)

11. A motor vehicle seat, comprising:
a) a first seat component,
b) a second seat component which can be pivoted about a pivot axis relative to the first seat component, the second seat component having a slotted guiding member,
c) a journal which is movably guided in the slotted guiding member of the second seat component, and
d) an actuator for displacing the journal within the slotted guiding member, wherein the first seat component has a slotted support member in which the journal is movably guided, wherein the slotted guiding member and the slotted support member intersect with each other in an intersection region.

12. The motor vehicle seat according to claim 11, wherein by displacing the journal within the slotted guiding member, the intersection region can be displaced along the slotted guiding member, whereby a relative angular position between the first seat component and the second seat component can be adjusted.

13. The motor vehicle seat according to claim 11, wherein the slotted guiding member and the slotted support member are arranged eccentrically relative above the pivot axis.

14. The vehicle seat according to claim 11, wherein a slotted guiding member, at least one slotted support member and a journal are arranged in each case at each of two sides of the second seat component.

15. The vehicle seat according to claim 11, wherein the first seat component and the second seat component overlap each other in an overlapping region, wherein the slotted guiding member and the slotted support member are arranged in the overlapping region.

16. The vehicle seat according to claim 11, wherein the journal and the slotted guiding member in at least one pivot direction form an end stop for the pivot movement of the second seat component relative to the first seat component about the pivot axis.

17. The vehicle seat according to claim 11, wherein the journal and the slotted support member in at least one pivot direction form an end stop for the pivot movement of the second seat component relative to the first seat component about the pivot axis.

18. The vehicle seat according to claim 11, wherein the vehicle seat is an integrated-belt seat.

19. The vehicle seat according to claim 18, wherein a belt outlet location is integrated in the second seat component.

20. The vehicle seat according to claim 19, wherein the first seat component has a first backrest side portion and a second backrest side portion, wherein the second backrest side portion in a transverse direction is arranged closer to the belt outlet location than the first backrest side portion, and the second backrest side portion has a first profile metal sheet and a second profile metal sheet which are connected to form a hollow profile, wherein both the first profile metal sheet and the second profile metal sheet in each case have a slotted support member which receive a common journal.

21. The vehicle seat according to claim 11, wherein the first seat component comprises a backrest lower portion of a backrest and the second seat component comprises a backrest upper portion.
